(19) United States
(12) Patent Application Publication
(10) Pub. No.: US 2002/0071650 A1
(43) Pub. Date: Jun. 13, 2002

(54) IMAGE PROCESSOR AND IMAGE PROCESSING SYSTEM USING THE IMAGE PROCESSOR

(76) Inventor: KATSUYUKI KANEKO, OSAKA (JP)

Correspondence Address: RATNER & PRESTIA, ONE WESTLAKES BERWYN, SUITE 301, PO BOX 980, VALLEY FORGE, PA, 194820980

(21) Appl. No.: 08/984,339

(22) Filed: Dec. 3, 1997

(30) Foreign Application Priority Data
Dec. 3, 1996 (JP) HEI 8-322565

(51) Int. Cl. H04N 5/76; H04N 5/225

(52) U.S. Cl. 386/46; 386/124; 386/117; 348/231

(57) ABSTRACT

The image processing system includes an encoder that digitalizes image data inputted from a video camera to convert the image data as digitalized into a data train of image segments made up of a header section, an information data section and an image data section; a CPU that digitalizes a measured data group from a plurality of measuring apparatuses to write the measured data group as digitalized to the information data section in the image segment; a data output apparatus that inputs and outputs the data train of the image segment with respect to a video storage apparatus; and a frame memory that reproduces the image data from the header section and image data section in the image segment and synthesizes data where the data of the information data section is superimposed on the image data to output the data as synthesized to a video display apparatus. With this structure, when the measured data outputted from the measuring apparatus and the image data associated with the measured data are synthesized to output a video data, a process of synthesizing the measured data is processed at a real time so that data or a pattern different from the measured value into the video data, etc., is enabled.

### BACKGROUND OF THE INVENTION

1. Field of the Invention

The present invention relates to an image processing unit and an image processing system using the unit, which are capable of, for example, storing and reproducing an image and data associated with the image simultaneously.

2. Related Art of the Invention

In recent years, an operation image has been recorded in a medical field, or an experiment image or an observation image has been recorded as measured data in an engineering experiment. For the clinical or experimental record of this type, video data mainly using VTR has been employed.

On the other hand, in the clinical or experimental field of this type, a variety of experimental parameters or measured data must be recorded in addition to the image.

Up to now, as a method of associating the image data with other data, there have been known a method of using a database technique and a method of directly writing data on image data.

In the former method of using the database, an image or a scene where an image is segmented is associated with data corresponding to the image or scene by a correspondence table that separately defines a relationship between the table that separately defines a relationship between the image or scene and the data. The correspondence table is designed in such a manner that, for example, a photographing time, a plurality of measured data or parameters, and a pointer to the image data (an identifier of a video tape, a value of a counter during reproduction, etc.) constitute one structural substance or a train of the correspondence table. In this method, in the case where a user wants to know the measured data corresponding to a reproduced image, the measured data can be obtained by looking over the correspondence table using the reproducing time.

The latter method of directly writing data on the image data has been frequently used for the production of program, etc., in a broadcasting station. In this method, a character is superimposed on a video image using a character generating unit at the time of reproducing the image, or the video signal is stored in a frame memory temporarily, and a character is drawn on the frame memory, to thereby directly associate the image with the data.

Subsequently, the structure of an image processing system according to the latter method will be described with reference to FIGS. 8 and 9.

In FIG. 8, reference numeral 100 denotes an image processing unit for processing video data; 101, a video camera that inputs a video signal to the image processing unit 100; and 102 and 103, measuring units that inputs measured data to the image processing unit 100 in the form of numerical or character data. Reference numeral 104 denotes a VTR that conducts a picture recording of the video data which has been processed by the image processing unit 100, and to which a video signal for the video camera are inputted. Reference numeral 105 denotes a TV that reproduces an image before or after being processed. FIG. 9 is a diagram showing an outline of an internal structure of the image processing unit 100. A bus 106 is connected with a CPU 107, a memory 108, a serial data interface 109, and a frame memory 110. The serial data interface 109 is connected with the measuring units 102 and 103 shown in FIG. 8. The frame memory 110 is connected with a video interface 111 through which the video signal is inputted from the video camera 1, etc., to the frame memory 110, and the video signal is outputted to the VTR or a TV from the frame memory 110.

Then, the operation of the image processing system thus structured will be briefly described. An image photographed by the video camera 101 is written to the frame memory 110 through the video interface 111. On the other hand, after the data sent out from the measuring units 102 and 103 is temporarily stored in the memory 108 and then converted into a character pattern train by the CPU 107, it is written at a predetermined position of the frame memory 110. The image data in the frame memory 110 is outputted to the VTR 104 or the TV 105 through the video interface 111. The operation of writing and reading the video data to and from the frame memory 110, and the operation of writing a character pattern thereto are conducted in synchronism with the video signal.

FIG. 10 shows an example of an image obtained by the above processing in the VTR 104 or the TV 105. The measured data obtained by the measuring units 102 and 103 is displayed on a screen at its upper and right side as numerical data, and also similarly, data produced inside of the image processing unit 100, such as time information, is displayed on the screen at its lower and right side as character data.

However, the above-mentioned former conventional method suffers from troublesomeness that the correspondence table is used and a defect that in the case of editing recorded data, since an address of the recorded data is changed, the correspondence table must be corrected every time the address is changed.

Also, in the latter conventional method, because the measured data is converted into the character pattern and then written directly to the frame memory, there arise the following problems in order to extract the measured data from the video data recorded in the VTR for reuse. That is, the method requires that a part of the character data is cut out, the measured data and the video data are separated from each other, and also the character data is reproduced as data using a character recognizing manner or the like, or that an operator reads the character data through his eyes, and again inputs data. Also, it is difficult to conduct a process of processing the measured data and again synthesizing data or a pattern different from a numeric value of the measured data with the video data, etc.

### SUMMARY OF THE INVENTION

The present invention has been made in order to solve the above problems with the conventional units, and therefore an object of the present invention is to provide an image processing unit through which it can be more easily conducted to process and edit image data and measured data associated with the image data in comparison with the conventional unit, and to provide an image processing system using that image processing unit.

In order to achieve the above object, according to a first aspect of the present invention, there is provided an image processing unit, comprising:

data converting means for producing a data segments, each said data segment having a header region, a measured data storage region and an image data storage region with respect to each frame of image data as inputted, and storing data of said frame in said image data storage region to output said data segment to which said frame data is stored;

memory means for temporarily storing said data segment outputted from said data converting means;

data writing means for digitalizing measured data relating to an object taken in said image data to write said measured data as digitalized in said measured data storage region of said data segment stored in said memory means; and

data output means for outputting a series of plural data segments including data segment to which said measured data is written.

According to a second aspect of the present invention, there is provided an image processing unit, comprising:

measured data writing means for producing data segments, each said data segment having a header region, a measured data storage region and an image data storage region with respect to each frame of image data as inputted, and digitalizing measured data relating to an object taken in said image data and writing said measured data as digitalized to said measured data storage region to output said data segment to which said measured data is written;

memory means for temporarily storing said data segment outputted from said measured data writing means;

frame data converting means for storing data of said frame in said image data storage region of said data segment stored in said memory means; and

data output means for outputting a series of plural data segments including data segment to which said measured data is written.

According to a third aspect of the present invention, there is provided an image processing system, comprising:

image data reconstructing means for reconstructing image data stored in said image data storage region of said data segment outputted from said data output means or outputted from recording medium in which output data from said data output means is recorded in the image processing apparatus according to the above first or second aspect of the present invention; and

image display data output means for producing display data using said measured data stored in said measured data storage region of said data segment outputted, for superimposing said display data on said image data as reconstructed, and for outputting said display data.

According to a fourth aspect of the present invention, there is provided an image processing system of the above second or third aspect of the present invention, further comprising:

change receiving means for receiving a change in a method of processing said measured data by said image display data output means and/or a change in a position at which said superimposing is made;

wherein said image display data output means conducts said production and/or said output based on a change instruction from said change receiving means.

According to a fifth aspect of the present invention, there is provided an image processing system comprising a video camera apparatus, a plurality of measuring apparatuses, a video data storage apparatus, a video display apparatus, and an image processing apparatus connected to said respective apparatuses;

wherein said image processing apparatus, comprising:

(1) data converting means for digitalizing image data inputted from said video camera apparatus to convert said image data into a series of image segments, each said image segment corresponding to one frame of said imege data and composed of a header section, an information data section and an image data section;

(2) data writing means for digitalizing a group of measured data relating to an object taken by said video camera apparatus, each of said measued data inputted from said plurality of measuring apparatuses to write said group of measured data to said information data section of said image segment;

(3) data output means for outputting a series of image segments including said image segments to which said group of measured data is written to said video data storage apparatus;

(4) image data reconstructing means for reconstructing said series of image segments using data of said header section and said image data section in said image segment;

(5) display data producing means for processing or synthesizing data of said information data section in said image segment to produce display data; and

(6) superimposed data output means for superimposing said display data as produced on said image data as reconstructed to output superimposed data to said video display apparatus.

According to a sixth aspect of the present invention, there is provided an image processing apparatus, comprising:

a bus for transfering data;

an image data input apparatus for digitalizing image data as inputted to output said image data to said bus;

a channel input apparatus for digitalizing a plurality of measured data relating to an object taken in said image data, said plurality of measured data inputted from a plurality of data channels to output said plurality of measured data to said bus, respectively; and

data converting and writing means for converting said image data outputted from said image data input apparatus into a series of image segments, each of said image segments corresponding to a frame of said image data and composed of a header section, an information data section and an image data section, and writing said plurality of measured data outputted from said channel input apparatus to the information data section of said image segment to output a series of said image segment to which said measured data is written.

According to a seventh aspect of the present invention, there is provided an image processing system, comprising:

a bus for transfering data;

an image data input apparatus for receiving said series of data and for outputting to said bus, said series of data outputted from either said data converting and writing means or a storage medium to which said data converting and writing means outputs said series of data, said data converting and writing means claimed in the image processing apparatus according to the above sixth aspect of the present invention;

a storage apparatus for storing said series of data outputted to said bus;

a frame memory connected to said bus;

a decoder for converting data of said header section and said image data section in each image segment of said series of image segments stored in said storage apparatus into image data to output said image data to said frame memory;

data superimposing means for controlling the transmission of said image segment to said decoder, producing display data using data of said information data section in said image segment, and superimposing said display data on said image data in said frame memory at a predetermined position to write display data; and

an image output apparatus for outputting said image data superimposed on said frame memory to an external device.

According to an eighth aspect of the present invention, there is provided an image processing system, comprising:

a bus for transfering data;

an image data input apparatus for digitalizing image data as inputted to output said image data to said bus;

a channel input apparatus for digitalizing a plurality of measured data relating to an object taken in said image data, said plurality ot measured data inputted from a plurality of data channels to output said plurality of measured data to said bus, respectively;

a frame memory connected to said bus;

data converting and writing control means for converting said image data digitalized and outputted from said image data input apparatus into a series of image segments, each of said image segments corresponding to a frame of said imgae data and composed of a header section, an information data section and an image data section, writing said plurality of measured data outputted from said channel input apparatus to said information data section of said image segment and for producing a predetermined superimposed image data based on said series of image segments;

a data output apparatus for outputting said series of image segments to which said measured data is written to said video storage apparatus;

a decoder for converting data of said image data section in said image segment into image data to output said image data to said frame memory; and

an image data output apparatus for outputting said superimposed image data to an external device;

wherein said data converting and writing control means produces display data using said measured data of said information data section in said image segment and superimposes said display data on said image data of said frame memory at a predetermined position to write said display data in the case of producing the predetermined superimposed image data based on data of said image segment.

According to a ninth aspect of the present invention, there is provided an image processing system according to the fifth, the seventh or the eighth aspect of the present invention, further comprising:

change receiving means for receiving a change in a method of processing said measured data and/or a change in a position at which said display data is superimposed when producing said display data;

wherein said method of processing of said measured data and/or said superimposed position is determined based on a change instruction from said change receiving means.

### BRIEF DESCRIPTION OF THE DRAWINGS

FIG. 1 is a diagram showing an internal structure of an image processing unit according to a first embodiment of the present invention;

FIG. 2 is a diagram showing the structure of a data segment according to the embodiment of the present invention;

FIG. 3 is a diagram showing an internal structure of an image processing unit according to a second embodiment of the present invention;

FIG. 4 is a diagram showing an example of an image screen produced by an image processing system according to the second embodiment of the present invention;

FIG. 5 is a diagram showing an internal structure of an image processing unit according to a third embodiment of the present invention;

FIG. 6 is a diagram showing the structure of a medical information collecting system according to the third embodiment of the present invention;

FIG. 7 is a diagram showing the structure of a data segment and an information data section in the data segment according to the same embodiment of the present invention;

FIG. 8 is a diagram showing a structural outline of an image processing system according to a prior art and the embodiment of the present invention;

FIG. 9 is a diagram showing an internal structure of a conventional image processing unit; and

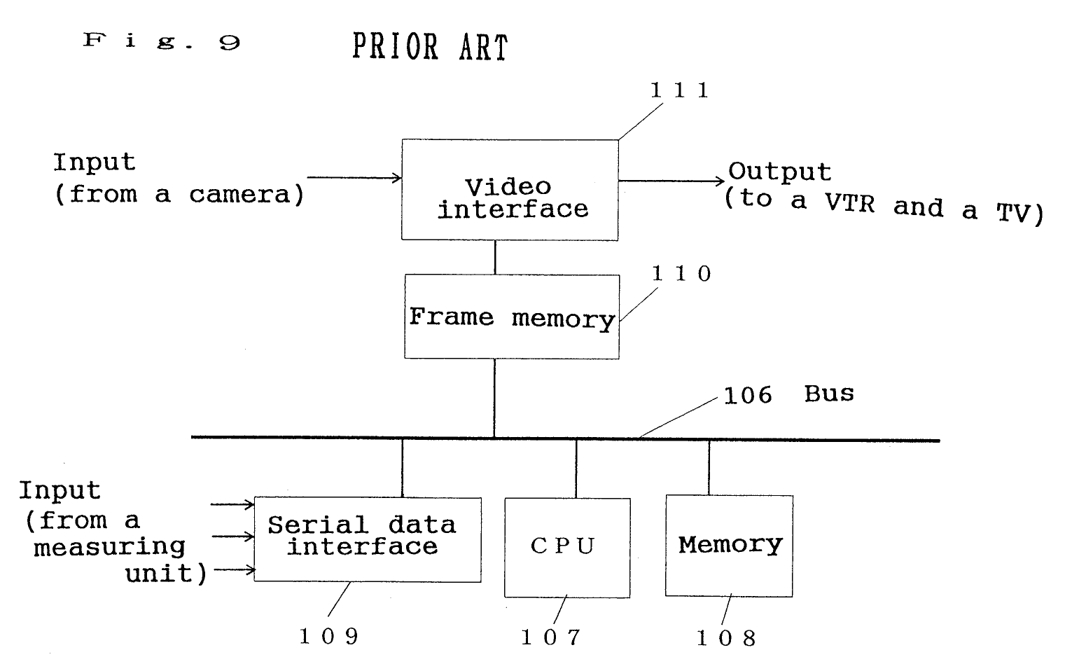

FIG. 10 is a diagram showing an example of an image screen produced by a conventional image processing system.

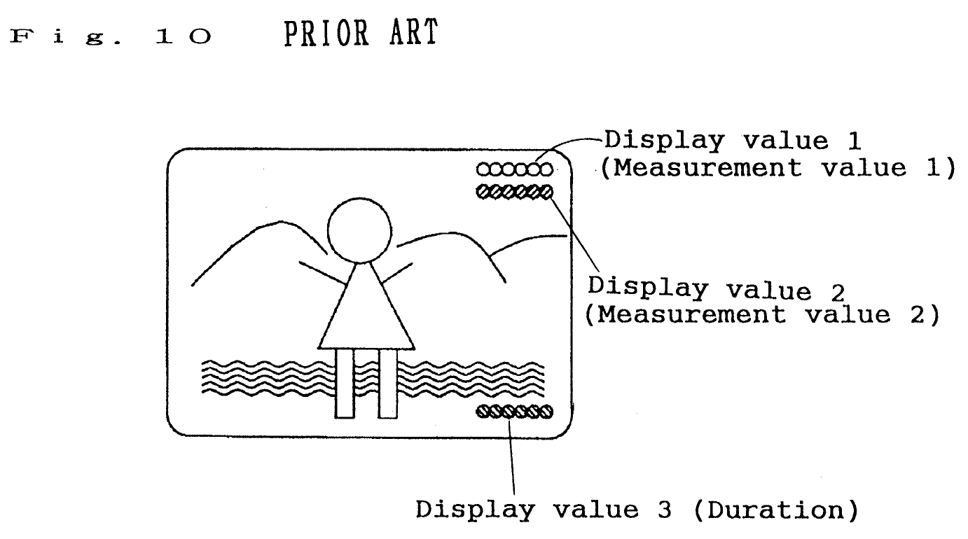

### DESCRIPTION OF THE REFERENCE NUMERALS

100 Image processing unit

101 Video camera

102 and 103 Measuring units

104 VTR

105 TV (television)

120 and 130 Buses

121 and 131 CPU

122 and 132 Memories

123 Serial data interface

124 and 134 Magnetic disc unit

125 Data output unit

126 Data input unit

127 Video encoder

136 Frame memory

137 Decoder

### DESCRIPTION OF THE PREFERRED EMBODIMENTS

Hereinafter, a description will be given of embodiments of the present invention with reference to the drawings.

(First Embodiment)

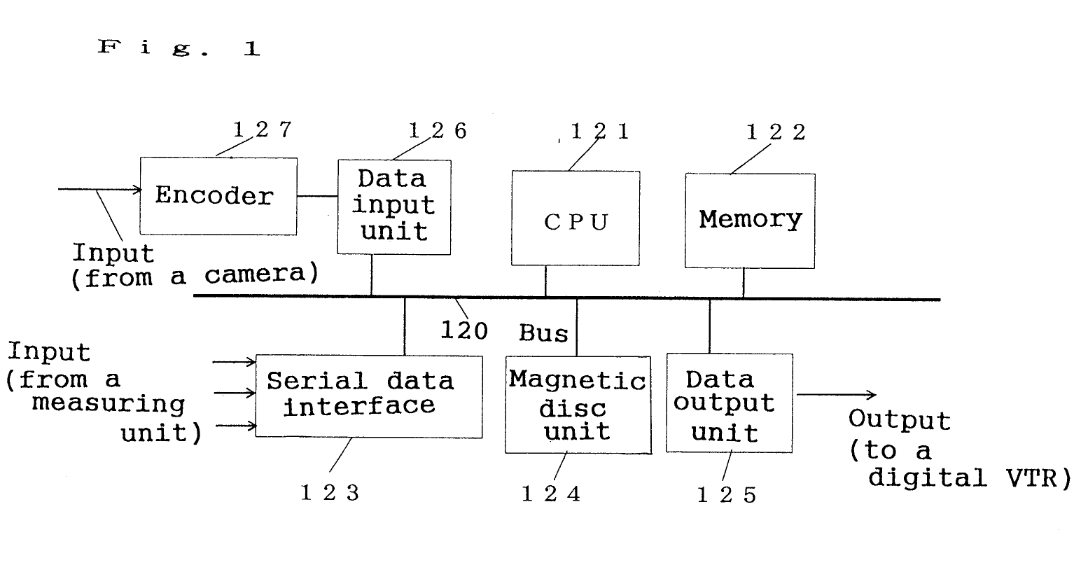

FIG. 1 is a block diagram showing an internal structure of an image processing unit used in an image processing system of the present invention, according to one embodiment.

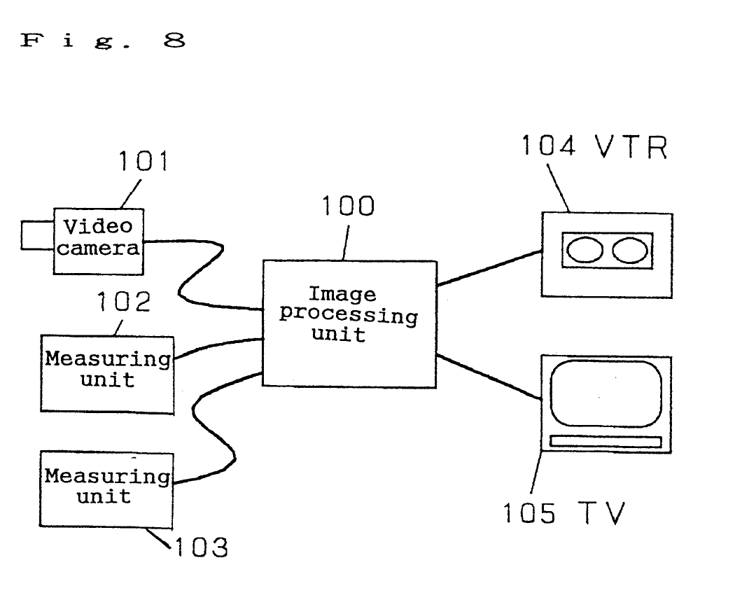

The schematic structure of the image processing system according to this embodiment as an example is substantially identical with the structure of FIG. 8 which was described in the conventional example.

Referring to those drawings, hereinafter, the structure of this embodiment will be described.

That is, as shown in FIG. 8, the image processing system according to this embodiment is made up of an image processing unit 100 that processes video data; a video camera 101 that inputs a video signal to the image processing unit 100; measuring units 102 and 103 that input measured data to the image processing unit 100 in the form of numerical or character data; a digital VTR 104; and a TV 105.

Also, as shown in FIG. 1, the image processing unit according to the present invention is structured in such a manner that a CPU 121, a memory 122, a serial data interface 123, a magnetic disc unit 124, a data output unit 125 and a data input unit 126 are connected to a bus 120 used for data transfer.

The serial data interface 123 is connected with measuring units 102 and 103 shown in FIG. 8. The data input unit 126 is connected with an encoder 127 for the video signal in such a manner that video data obtained by photographing due to the video camera 101 is digitalized and data-compressed by the encoder 127 and then outputted to the bus 120 through the data input unit 126. The data output unit 125 is designed so as to receive data from the bus 120 and output the video data to the digital VTR 104.

The encoder 127 is designed to convert the video signal as inputted into a train of data segments which are segmented in a frame unit.

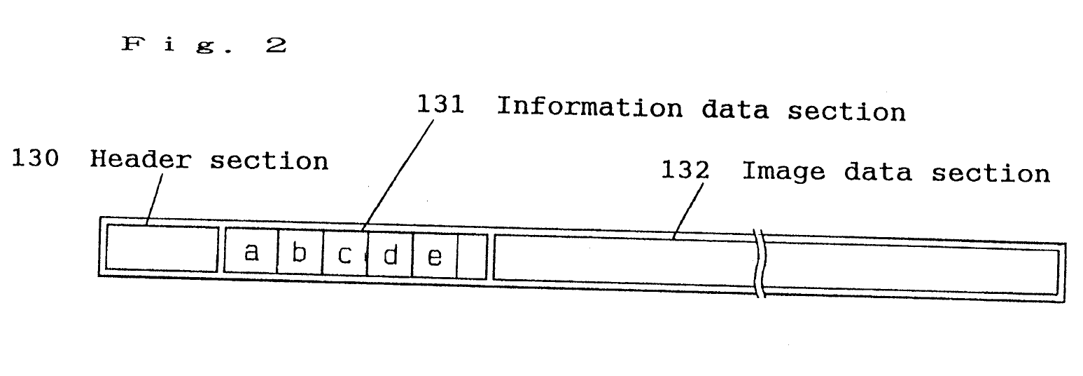

FIG. 2 is a diagram showing the structure of the data segment. In other words, the data segment is made up of a header section 130, an information data section 131, and an image data section 132. The header section 130 includes data segment No., time information, a user's or device's identifier, and so on, and the image data section 132 stores the video data as data-compressed therein. The information data section 131 stores non-image data relating to the image data section therein.

In this example, the data converting means according to the present invention corresponds to the encoder 127. Also, the function of the data writing means according to the present invention is realized by a processing due to the CPU 121 which will be described later. The data converting and writing means according to the present invention is means including the encoder 127 and so on. The channel input unit according to the present invention corresponds to the serial data interface 123. The data output means according to the present invention corresponds to the data output unit 125. The measured data storage region according to the present invention corresponds to the information data section 131.

Subsequently, the operation of the image processing system thus structured will be described.

An image photographed by the video camera 101 is segmented by the encoder 127 as shown in FIG. 2, and then written to the memory 122 through the data input unit 126 and the bus 120.

On the other hand, the measured data sent out from the measuring units 102 and 103 is stored in another region of the memory 122 through the serial data interface 123, and also subjected to calculation between the measured data, conversion into an appropriated character train or numeral train, visualizing processing and so on by the CPU 121. In this example, the image processing unit may be structured so that the measured data is not subjected to the visualizing processing.

The measured data thus processed is written to the information data section 131 (refer to FIG. 2) of the data segment in the memory 122 according to an instruction from the CPU 121. The data segment in the memory 122 to which the measured data is written in the above manner is recorded by the CPU 121 in the magnetic disc unit 124, or the external digital VTR 104 through the data output unit 125.

The input of the image data to the data input unit 126, the writing of the image data to the memory 122, the writing of the measured data from the serial interface 123 to the memory 122, and the updating of the information data section of the data segment in the memory are conducted in synchronism with the video signal inputted to the encoder 127.

As described above, according to this embodiment, the data input unit 126 and the serial data interface 123 are connected to the bus 120, and the segmented image data including the information data section is stored in the interior of the unit or the external storage unit through the memory, thereby being capable of writing the measured data received by the serial data interface 123 and the information obtained by processing the measured data to the information data section of the data segment, as a result of which the image data and the measured data having a temporal relationship with the image data can be stored simultaneously. Also, even if the video data thus produced is edited or processed according to the unit of segments, the relationship between the image and the measured data which are stored in segment is saved.

(Second Embodiment)

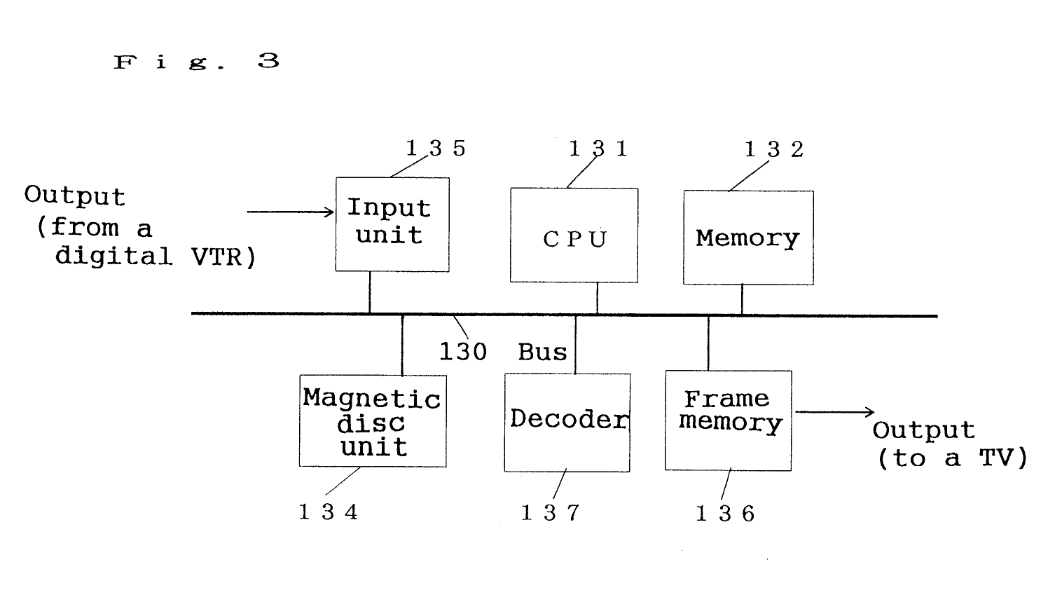

FIG. 3 is a schematic structural diagram showing an internal structure of the image processing unit used in the image processing system of the present invention, according to another embodiment.

The schematic structure of the image processing system according to this embodiment as an example is substantially identical with the structure of FIG. 8 which was described in the conventional example.

This embodiment is implemented on the assumption that a digital VTR 104 or a magnetic disc unit 134 in which a data train of data segment to which measured data is written is stored, is employed as in the first embodiment.

Referring to those drawings, hereinafter, the structure according to this embodiment will be described.

That is, as shown in FIG. 8, the image processing system according to this embodiment is made up of an image processing unit 100 that processes video data; a video camera 101 that inputs a video signal to the image processing unit 100; measuring units 102 and 103 that input measured data to the image processing unit 100 in the form of numerical or character data; a digital VTR 104; and a TV 105.

Also, as shown in FIG. 3, the image processing unit according to the present invention is structured in such a manner that a CPU 131, a memory 132, a magnetic disc unit 134, an input unit 135, a frame memory 136 and a decoder 137 are connected to a bus 130 to be used for data transfer.

As shown in FIG. 3, the input unit 135 is connected with the digital VTR 104 as described in the first embodiment. Therefore, to the input unit 135 are inputted a data train of data segment having an information data section 131 to which measured data or data obtained by processing the measured data is written as shown in FIG. 2. Also, the data formation like this, that is, image data as a data train of the above data segment are also recorded in the magnetic disc unit 134.

In this example, the image data reproducing means according to the present invention corresponds to a decoder 137. Also, the image display data output means according to the present invention is means including the frame memory 136, the CPU 131 and so on. Further, the function of the display data producing means according to the present invention is realized by a processing due to the CPU 131.

Subsequently, the operation of the image processing system thus structured will be described.

A data segment array inputted from the input unit 135 or a data segment array read from the magnetic disc unit 134 are temporarily stored in the memory 132.

The measured data written in the information data section 131 of the data segment in the memory 132 is copied in another region of the memory 132. Also, the data segment array is transferred to the decoder 137 so as to be data-expanded by the decoder 137, and the resultant image data is reproduced in the frame memory 136.

On the other hand, the measured data written upon recording is extracted from the information data section which is copied in another region of the memory 132 as mentioned above, and also subjected to calculation between the measured data, conversion into an appropriated character train or numeral train, visualizing processing for making a graph and so on by the CPU 131. Then, the measured data thus processed is written on the image data of the frame memory 136 at a predetermined position in a superimposed manner. Through the processing, the image in the frame memory 136 is such that the measured data contained in the information data section 131 is visualized and superimposed on the image obtained by decoding the video data. The superimposed data outputted from the frame memory 136 is converted into a video signal and displayed by the external TV 105.

The transfer of the data segment from the memory 132 to the decoder 137, the writing of the video data to the frame memory 136, and the writing of the data to the frame memory 136 by the CPU 131 are conducted in synchronism with the video signal outputted from the frame memory 136.

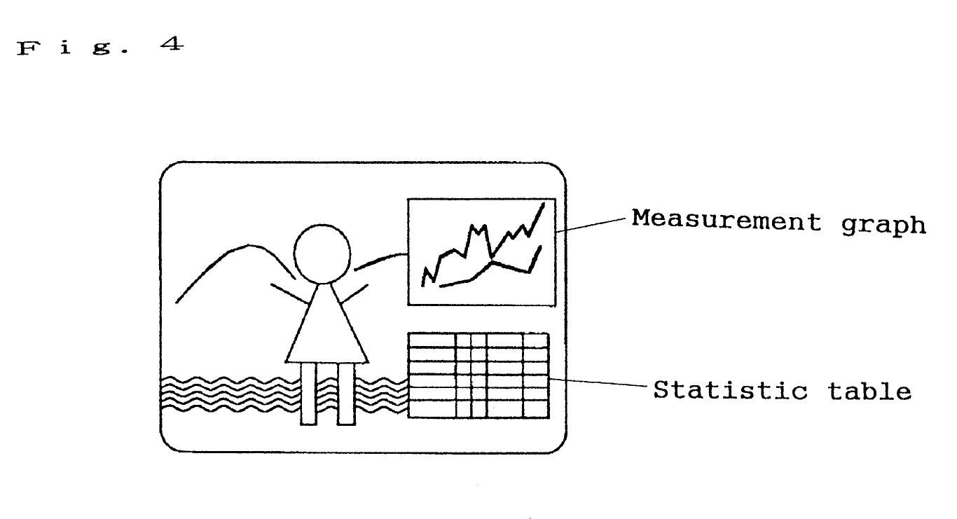

FIG. 4 is an example of an image displayed in the TV 105 through the above processing.

That is, a temporal change in measured data obtained by the measuring units 102 and 103 is displayed on the upper and right side of a screen as a graph, and also a table representative of the dispersion of the measured data produced inside of the image processing unit 100 is displayed on the lower and right side of the screen as character data. In this way, in order to allow the state of the temporal change including the past history of the measured data to be displayed in the form of a graph, the past graph display data is stored in a specific region of the memory 132 as it is. In other words, it is designed such that a graph of new measured data written to the information data section 131 is added to the stored graph display data.

As described above, according to this embodiment, the input unit 135 or the magnetic disc unit 134 is connected to the bus 130, the segmented image data including the information data section from those units is reproduced in the frame memory 136 through the memory 132 and the decoder 137, the data in the information data section 131 is extracted from the data segment latched in the memory 132, and the information obtained by processing the extracted data is superimposed on the image data in the frame memory 136, thereby being capable of displaying the image data and the measured data having a temporal close relationship with the image data in the superimposed manner.

In this case, if software relating to the display processing is altered, the processing method, the display method, the display position, etc., for the measured data, can be altered at a real time at the time of reproducing the image. The software selecting/changing instruction can be simply performed by an operator through a key board (omitted from the drawing) connected to the bus 130 or the like.

(Third Embodiment)

In the above first embodiment, there was described a case in which the measured data inputted from the serial interface 123 is inserted into the information data section 131 of the image data which is sent from the video camera 101 and converted into the data segment train, and recorded in the external VTR 104 or the magnetic disc unit 124 through the data output unit 125.

Also, in the second embodiment, there was described a case in which the information data section 131 of the data segment array obtained from the external VTR 104 through the input unit 135, or the information data section 131 of the data segment array obtained from the magnetic disc unit 134 is extracted and then superimposed on the image data in the frame memory 136.

By combining those two embodiments together, there can be structured that the measured data inputted from the serial data interface 123 is inserted into the information data section 131 of the image data which is sent from the video camera and converted into the data segment array to produce a new data segment array, and simultaneously a data pattern obtained by processing or editing the measured data, etc. is superimposed on the frame memory.

An embodiment of this case will be described hereinafter.

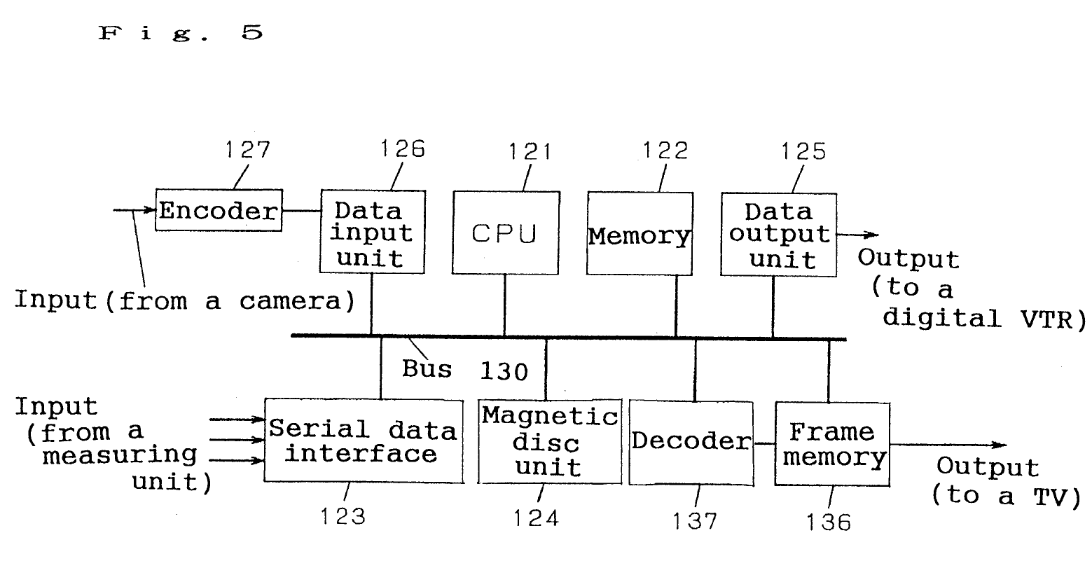

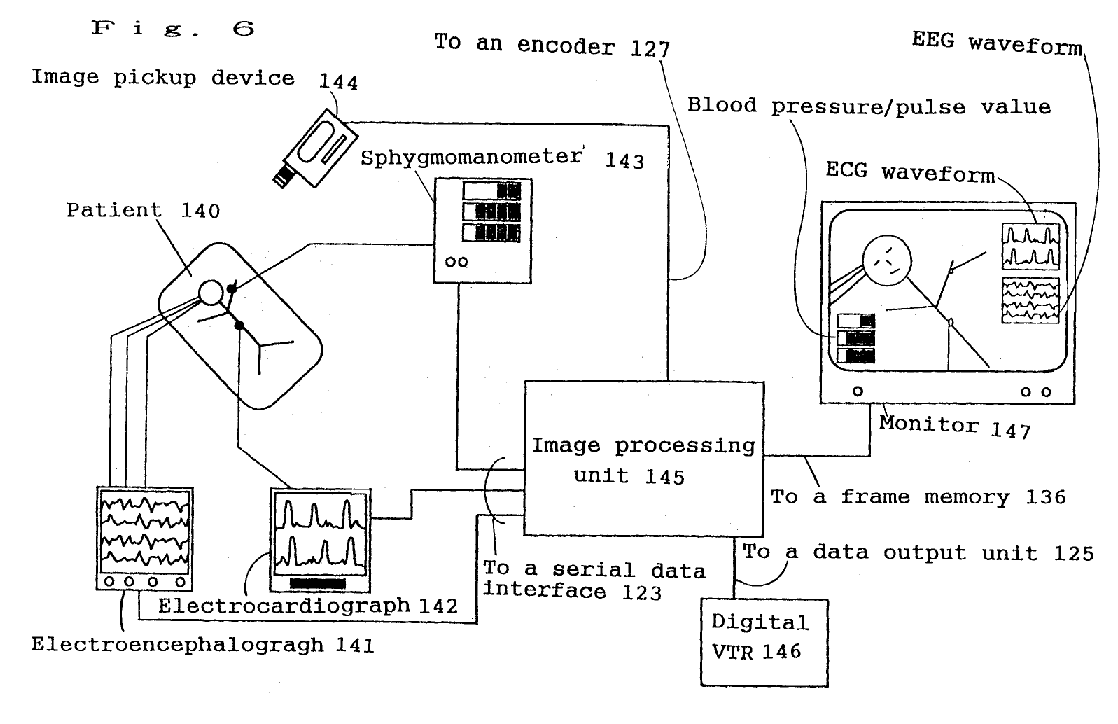

FIG. 5 is a structural diagram showing an image processing unit according to an embodiment of the present invention. FIG. 6 is a structural diagram showing a medical information collecting system as the image processing system according to the embodiment of the present invention. The medical information collecting system shown in FIG. 6 uses the image processing unit shown in FIG. 5. Also, in FIG. 5, parts identical with those described in FIGS. 1 and 3 are indicated by the same references.

As shown in FIG. 6, to a patient 140 are attached an electroencephalograph 141, an electrocardiograph 142 and a sphygmomanometer 143. The patient 140 is monitored by an image pickup device 144. Reference numeral 145 denotes an image processing unit shown in FIG. 5. The electroencephalograph 141, the electrocardiograph 142 and the sphygmomanometer 143 have a digital output terminal, respectively, and those output terminals are connected to the serial data interface 123 (refer to FIG. 5) within the image processing unit 145. The image pickup unit 144 is connected to an encoder 127 shown in FIG. 5, the digital VTR 146 is connected to the data output unit 125, and the monitor unit 147 is connected to the frame memory 136, respectively.

The operation of the respective sections in the image processing unit 145 shown in FIGS. 5 and 6 is basically identical with the contents described in the above embodiments.

Hereinafter, the operation of this embodiment will be described in more detail with reference to FIGS. 5 and 6.

That is, the image data of the patient 140 inputted from the image pickup device 144 is digitalized by the encoder 127, then formatted through the data input unit 126, and temporarily latched in the memory 122 (refer to FIG. 5).

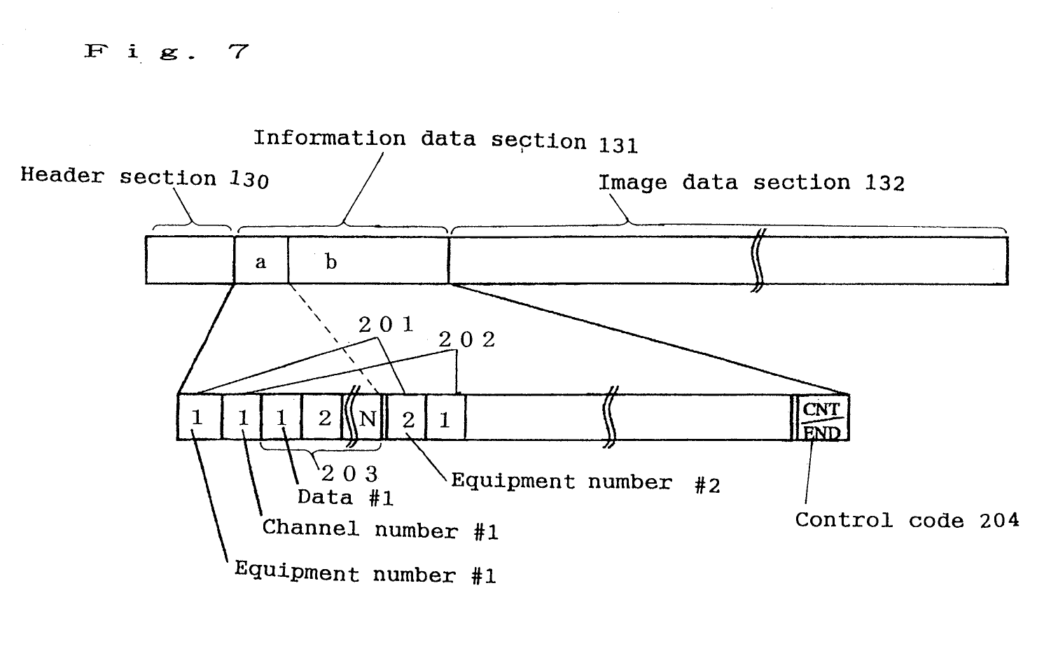

On the other hand, the data from the respective measuring units 141 to 143 which is inputted to the serial data interface 123 is written to a predetermined region of the information data section 131 (refer to FIG. 2) in the data segment which has been already temporarily latched in the memory 122 as described above. For example, the measured data from the brain wave meter 141 is written to a region a of the information data section 131 shown in FIG. 2, the measured data from the electrocardiograph 142 is written to a region b thereof, and the measured data from the sphygmomanometer 143 is written to a region c thereof, respectively. The structure of the information data section 131 will be described in more detail with reference to FIG. 7.

The data segment to which the measured data is written in this way is transferred to the magnetic disc unit 124.

A series of operation as described above is repeated for each frame of image data outputted from the image pickup unit 144.

Also, the data segment in the magnetic disc unit 124 or the memory 122 is transferred to the digital VTR 146 through the data output unit 125 when a given amount of data is stored in the data segment.

On the other hand, as described above, the data train of the data segment stored in the magnetic disc 124 is transferred to the memory 122 and then transferred to the decoder 137. Alternatively, as described above, there may be structured such that the data train of the data segment where the respective measured data has been written to the predetermined region of the information section 131 in the memory 122 is transferred directly to the decoder 137 not through the magnetic disc unit 124. After the data segment transferred to the decoder 137 is expanded in the decoder 137, that is, decoded so that the image data is reproduced, it is written to the frame memory 136. Also, the measured data stored in the information data section 131 of the data segment in the memory 122 is extracted by the CPU 121, processed and then written so as to be superimposed on the image data in the frame memory 136 at a predetermined position thereof.

In the above manner, the image data written so as to be superimposed on the frame memory 136 is outputted to the monitor 147 shown in FIG. 6.

The exemplary display of an image in the system according to this embodiment is indicated on a display screen of the monitor 147 shown in FIG. 6. In other words, as shown in the figure, a numeric value of blood pressure/pulse value is directly indicated on the image of the patient 140 in the above display screen, and also a window image representative of the waveforms of an electrocardiogram and an electroencephalograph is indicated.

With the above structure, the measured data can be displayed so as to be superimposed on the image data without processing an original image obtained from the image pickup unit 144, or can be recorded in the digital VTR 146.

Also, as change receiving means for selecting desired measured data from plural kinds of measured data or for receiving a change in a method of processing the measured data or a change in a position at which the display data is superimposed on each other when producing those display data, a key board (omitted from the drawing) is connected to the bus 130 with the result that the following advantages are exhibited.

That is, the selection of the measured data to be displayed or a change in processing (for example, processing such as graphing or waveform display) can be readily performed according to a change instruction from the key board by the operator, and a change in a position at which the measured data is superimposed on the image data can be also readily performed. In this case, it is needless to say that a plurality of processing programs need to be provided for executing those different processing.

Also, if the data segment is stored in the magnetic disc unit 124, a past image at an arbitrary time is processed to a desired display mode or desired display contents so that the image can be displayed on the monitor 147.

As described above, the structure of the information data section 131 will be described in more detail with reference to FIG. 7.

FIG. 7 is a diagram showing a structure of the data segment and the information data section 131 in the data segment according to this embodiment.

That is, as shown in the figure, the information data section 131 is made up of a train consisting of device Nos. 201 for identifying the kind of various measuring units, channel Nos. 202 for identifying, when outputting a plurality of data by one measuring unit, those data, and data blocks 203 corresponding to the respective channel Nos. Further, at a last position of the information data section 131 is added a control code 204 indicating whether the data block train continues up to the information data section 131 in a data segment corresponding to a succeeding frame, or not. Even if, when a measurement time interval of the measuring unit is lower than a frame rate of the image data, the amount of measured data outputted from the measuring unit is as large as the data cannot be received in one information data section 131, the control code 204 enables those measured data to be divided into a plurality of data segments and written.

In the above way, the inside of the information data section 131 is not structured in such a manner that it is sectioned into a plurality of regions in advance so that the measured data of the plural devices can be written. In other words, since the timings of outputting the measured data from the respective devices are different from each other, for example, as shown in FIG. 6, this embodiment is structured such that the measured data from three kinds of devices is inputted to the image processing unit 145. However, at a timing when there is no output from the electrocardiograph 142 and the sphygmomanometer 143, the region of the information data section 131 may be occupied by only the measured data of the electroencephalograph 141 having a large amount of measured data. With this structure, the region of the information data section 131 can be efficiently utilized.

As described above, the present invention can obtain the remarkable advantages such that the image data from the video camera and the measured data from the plural measuring units can be stored while keeping a temporal relationship therebetween, and also the measured data and the information obtained by processing the measured data can be displayed simultaneously and freely without damaging the image data.

In the above embodiment, a description was given of a case in which after the image data is segmented, the measured data is written to the information data section. However, the present invention is not limited by or to this structure, but for example, the image data may be stored in the image data section after the measured data is written to the information data section in advance. In this case, the image processing unit is provided with: measured data writing means for producing a data segment having a header region, a measured data storage region and an image data storage region with respect to each frame of image data as inputted, and digitalizing measured data of said image data relating to an object to be photographed and writing the measured data as digitalized to said measured data storage region to output the data segment to which the measured data is written; memory means for temporarily latching said data segment outputted from said measured data writing means; frame data converting means for storing the data of said frame in said image data storage region of said data segment which is latched in said memory means; and data output means for outputting a train of plural data segments including the data segment to which the measured data is written.

Also, in the above embodiment, a description was given of a case in which the image data is segmented by the encoder. However, the present invention is not limited by or to this structure, but for example, the image data may be segmented by the data converting/writing control means. In other words, the image processing system in this case is, for example, provided with: a bus used for data transfer; an image data input unit for digitalizing image data as inputted to output the image data to said bus; a channel input unit for digitalizing a plurality of measured data of said image data relating to an object to be photographed which are inputted from a plurality of data channels to output the plurality of measured data to said bus, respectively; a frame memory connected to said bus; data converting/writing control means for converting said image data digitalized and outputted from said image data input unit into a data train of an image segment which is represented by a frame unit made up of a header section, an information data section and an image data section, writing said measured data group outputted from said channel input unit to said information data section of said image segment to produce a predetermined superimposed image data on the basis of the data of the image segment; a data output unit for outputting the data train of said image segment to which said measured data is written to a video storage unit; a decoder for converting the data of said image data section in said image segment into image data to output the image data to said frame memory; and an image data output unit for outputting said predetermined superimposed image data to an exterior; wherein said data converting/writing control means produces display data using said measured data of said information data section in said image segment and superimposes the display data on said image data of said frame memory at a predetermined position to write the display data in the case of producing the predetermined superimposed image data on the basis of the data of said image segment. Thus, said image data output unit is designed to output the superimposed image data as said predetermined image display data.

Also, the processing operation of the respective means in the above embodiment may be realized in a software fashion by the action of program using a computer, or the above processing operation may be realized in a hardware fashion by an unique circuit structure without using the computer.

As was apparent from the above description, the present invention has the advantage that the process of processing and editing the measured data associated with the image data can be more easily performed in comparison with the prior art.

What is claimed is:

1. An image processing apparatus, comprising:
data converting means for producing a data segments, each said data segment having a header region, a measured data storage region and an image data storage region with respect to each frame of image data as inputted, and storing data of said frame in said image data storage region to output said data segment to which said frame data is stored;
memory means for temporarily storing said data segment outputted from said data converting means;
data writing means for digitalizing measured data relating to an object taken in said image data to write said measured data as digitalized in said measured data storage region of said data segment stored in said memory means; and
data output means for outputting a series of plural data segments including data segment to which said measured data is written.

2. An image processing apparatus, comprising:
measured data writing means for producing data segments, each said data segment having a header region, a measured data storage region and an image data storage region with respect to each frame of image data as inputted, and digitalizing measured data relating to an object taken in said image data and writing said measured data as digitalized to said measured data storage region to output said data segment to which said measured data is written;
memory means for temporarily storing said data segment outputted from said measured data writing means;
frame data converting means for storing data of said frame in said image data storage region of said data segment stored in said memory means; and
data output means for outputting a series of plural data segments including data segment to which said measured data is written.

3. An image processing system, comprising:
image data reconstructing means for reconstructing image data stored in said image data storage region of said data segment outputted from said data output means or outputted from recording medium in which output data from said data output means is recorded in the image processing apparatus as claimed in claim 1 or 2; and
image display data output means for producing display data using said measured data stored in said measured data storage region of said data segment outputted, for superimposing said display data on said image data as reconstructed, and for outputting said display data.

4. An image processing system according to claim 2 or 3, further comprising:
change receiving means for receiving a change in a method of processing said measured data by said image display data output means and/or a change in a position at which said superimposing is made;
wherein said image display data output means conducts said production and/or said output based on a change instruction from said change receiving means.

5. An image processing system comprising a video camera apparatus, a plurality of measuring apparatuses, a video data storage apparatus, a video display apparatus, and an image processing apparatus connected to said respective apparatuses;
wherein said image processing apparatus, comprising:
(1) data converting means for digitalizing image data inputted from said video camera apparatus to convert said image data into a series of image segments, each said image segment corresponding to one frame of said imege data and composed of a header section, an information data section and an image data section;
(2) data writing means for digitalizing a group of measured data relating to an object taken by said video camera apparatus, each of said measued data inputted from said plurality of measuring apparatuses to write said group of measured data to said information data section of said image segment;
(3) data output means for outputting a series of image segments including said image segments to which said group of measured data is written to said video data storage apparatus;
(4) image data reconstructing means for reconstructing said series of image segments using data of said header section and said image data section in said image segment;
(5) display data producing means for processing or synthesizing data of said information data section in said image segment to produce display data; and
(6) superimposed data output means for superimposing said display data as produced on said image data as reconstructed to output superimposed data to said video display apparatus.

6. An image processing apparatus, comprising:
a bus for transfering data;
an image data input apparatus for digitalizing image data as inputted to output said image data to said bus;
a channel input apparatus for digitalizing a plurality of measured data relating to an object taken in said image data, said plurality of measured data inputted from a plurality of data channels to output said plurality of measured data to said bus, respectively; and
data converting and writing means for converting said image data outputted from said image data input apparatus into a series of image segments, each of said image segments corresponding to a frame of said image data and composed of a header section, an information data section and an image data section, and writing said plurality of measured data outputted from said channel input apparatus to the information data section of said image segment to output a series of said image segment to which said measured data is written.

7. An image processing system, comprising:
a bus for transfering data;
an image data input apparatus for receiving said series of data and for outputting to said bus, said series of data outputted from either said data converting and writing means or a storage medium to which said data converting and writing means outputs said series of data, said data converting and writing means claimed in the image processing apparatus according to claim 6;
a storage apparatus for storing said series of data outputted to said bus;
a frame memory connected to said bus;
a decoder for converting data of said header section and said image data section in each image segment of said series of image segments stored in said storage apparatus into image data to output said image data to said frame memory;
data superimposing means for controlling the transmission of said image segment to said decoder, producing display data using data of said information data section in said image segment, and superimposing said display data on said image data in said frame memory at a predetermined position to write display data; and
an image output apparatus for outputting said image data superimposed on said frame memory to an external device.

8. An image processing system, comprising:
a bus for transfering data;
an image data input apparatus for digitalizing image data as inputted to output said image data to said bus;
a channel input apparatus for digitalizing a plurality of measured data relating to an object taken in said image data, said plurality ot measured data inputted from a plurality of data channels to output said plurality of measured data to said bus, respectively;
a frame memory connected to said bus;
data converting and writing control means for converting said image data digitalized and outputted from said image data input apparatus into a series of image segments, each of said image segments corresponding to a frame of said imgae data and composed of a header section, an information data section and an image data section, writing said plurality of measured data outputted from said channel input apparatus to said information data section of said image segment and for producing a predetermined superimposed image data based on said series of image segments;
a data output apparatus for outputting said series of image segments to which said measured data is written to said video storage apparatus;
a decoder for converting data of said image data section in said image segment into image data to output said image data to said frame memory; and
an image data output apparatus for outputting said superimposed image data to an external device;
wherein said data converting and writing control means produces display data using said measured data of said information data section in said image segment and superimposes said display data on said image data of said frame memory at a predetermined position to write said display data in the case of producing the predetermined superimposed image data based on data of said image segment.

9. An image processing system according to claim 5, further comprising:
change receiving means for receiving a change in a method of processing said measured data and/or a change in a position at which said display data is superimposed when producing said display data;
wherein said method of processing of said measured data and/or said superimposed position is determined based on a change instruction from said change receiving means.

10. An image processing system according to claim 7, further comprising:
change receiving means for receiving a change in a method of processing said measured data and/or a change in a position at which said display data is superimposed when producing said display data;
wherein said method of processing of said measured data and/or said superimposed position is determined based on a change instruction from said change receiving means.

11. An image processing system according to claim 8, further comprising:
change receiving means for receiving a change in a method of processing said measured data and/or a change in a position at which said display data is superimposed when producing said display data;
wherein said method of processing of said measured data and/or said superimposed position is determined based on a change instruction from said change receiving means.
